(19) United States
(12) Patent Application Publication
(10) Pub. No.: US 2024/0052125 A1
(43) Pub. Date: Feb. 15, 2024

(54) HIERARCHICAL POROUS POLYMERIC MATERIAL AND PREPARATION METHOD THEREOF

(71) Applicant: SHAANXI NORMAL UNIVERSITY, Xi'an (CN)

(72) Inventors: Yu Fang, Xi'an (CN); Pei Wang, Xi'an (CN); Junxia Peng, Xi'an (CN); Yinan He, Xi'an (CN); Jiaojiao Liu, Xi'an (CN)

(21) Appl. No.: 18/494,789

(22) Filed: Oct. 26, 2023

Related U.S. Application Data
(63) Continuation-in-part of application No. PCT/CN2022/103031, filed on Jun. 30, 2022.

(30) Foreign Application Priority Data
Feb. 23, 2022 (CN) 202210170885.4

(51) Int. Cl. C08J 9/28

(52) U.S. Cl. CPC C08J 9/283; C08J 2201/0504; C08J 2325/14; C08J 2205/044

(57) ABSTRACT

A hierarchical porous polymeric material and its preparation method in the field of porous polymeric materials provided. The preparation method comprises: (1) mixing hydrophobic silica particles, an initiator, a polymerizable monomer, a crosslinking agent, a co-crosslinking agent and a pore-forming agent together, uniformly stirring to obtain a reaction mixture; (2) adding water into the reaction mixture and stirring until a gel emulsion is formed; and (3) carrying out staged thermal polymerization on the gel emulsion to obtain the hierarchical porous polymeric material. The present application can effectively regulate and control the contents and sizes of pores and throats, and obtain a material with hierarchical micro-porous structures. The good heat transfer and zero explosion in the polymerization process enable high product qualification rate. The wet material has rich pores, small resistance in mass transfer process and fast drying rate. Meanwhile, the obtained material has excellent machinability and static load resistance.

### TECHNICAL FIELD

The present application belongs to the field of porous polymeric materials, in particular to a hierarchical porous polymeric material and a preparation method thereof.

### BACKGROUND

Porous materials have the advantages of low relative density, high specific strength, large specific surface area, sound insulation and heat insulation, which make them have unique advantages in industrial catalysis, environmental energy, adsorption separation, weight reduction and energy saving, biomedicine and the like. Therefore, the preparation of porous materials has always been the focus of attention.

At present, the commonly used preparation methods of porous materials mainly include gas foaming methods, solvent pore-forming methods and template methods. Compared with foaming methods and solvent pore-forming methods, the template methods are favored because of its advantages of easy and accurate control of pore size and distribution. Gel emulsions are common templates for preparing low-density porous materials. Gel emulsions are also called highly concentrated emulsions and high internal-phase ratio emulsions. It has been reported that the volume fraction of the dispersed phase in the traditional gel emulsion method must be greater than 74% (the critical value when dispersed-phase droplets are densely packed into interconnected spheres), so the density of porous materials prepared by this method is lower than 0.30 g/cm³. When the volume fraction of the dispersed phase is more than 90% or even more, pore throats will be formed on the pore walls of the porous material (the material density is less than 0.10 g/cm³), and the internal system of the material has partially interpenetrating open pores, but at this time, the mechanical property of the porous material will be greatly affected, showing low mechanical strength and machinability, and the application fields and occasions are greatly limited. For porous materials with a density greater than 0.10 g/cm³, if pore throats and partially interpenetrating open porous structures are to be formed in the internal system of the material, it is usually achieved by introducing surfactants into a gel emulsion system to reduce the interfacial tension of the gel emulsion system. However, this method has some defects such as instability and easy demulsification of the prepared gel emulsion, and problems that surfactant leakage and secondary pollution are also likely to occur in the later use of the porous material.

For applications with high mechanical property and machining requirements, porous materials with a high density (0.20-0.60 g/cm³) are usually needed. However, there are many continuous phases (oil phases) in the preparation process of such materials, and a large amount of polymerization heat will be generated in the process of oil-phase polymerization. If the heat is not properly controlled, the problem of explosive polymerization will easily occur, and the fraction defective of the obtained materials will be high, resulting in great security risks. In addition, if the content of the continuous phases (oil phases) is high, the oil film in the prepared W/O type (water-in-oil) gel emulsion is thicker and has a continuous structure, and the porous material obtained by polymerization is a closed-pore type, which makes the drying from wet materials to dry materials more energy-consuming, the mass transfer process is extremely difficult, the drying cost is much higher, and the scaled-up production and wide application of the materials are greatly limited. Therefore, a high-density porous material (0.20-0.60 g/cm³) with good heat transfer in the preparation process, small mass transfer resistance in the later drying process and excellent mechanical properties and machinability of the final product and the preparation method thereof are research difficulties.

### SUMMARY

The object of the present application is to overcome the shortcomings of the existing technology and provide a polymer material with hierarchical porous structure and a preparation method thereof.

In order to achieve the above object, the following technical solution is adopted in the present application:

the present application relates to a method for preparing a hierarchical porous polymeric material, and the method includes the following steps:
(1) mixing hydrophobic silica particles with an initiator, adding a polymerizable monomer, a crosslinking agent, an auxiliary crosslinking agent and a pore-forming agent, and uniformly stirring to obtain a reaction mixture;
(2) adding water into the reaction mixture and stirring until a gel emulsion is formed;
wherein in the gel emulsion, in parts by weight, 0.40-1.20 parts of hydrophobic silica particles, 0.40-1.20 parts of the initiator, 12.86-44.35 parts of the polymerizable monomer, 2.88-8.64 parts of the crosslinking agent, 0.58-1.73 parts of the auxiliary crosslinking agent and 0.96-8.64 parts of the pore-forming agent are contained per 40-60 parts of deionized water;
the polymerizable monomer is one or more of p-chlorostyrene, m-chlorostyrene, o-chlorostyrene, styrene, α-methylstyrene, 2-methylstyrene, 4-methylstyrene and 4-ethylstyrene;
the pore-forming agent is one or two of polylactic acid, polyacrylamide, polycarbonate, polyvinyl chloride paste resin, polyvinyl alcohol and polyvinyl acetate with a number average molecular weight of 10,000-80,000; and
(3) carrying out staged thermal polymerization on the gel emulsion, which reacting at room temperature to 40° C. for 4-8 h, and heating to 70-90° C. for reacting for 4-12 h to complete polymerization, and drying to obtain the hierarchical porous polymeric material.

Further, the crosslinking agent is one of divinylbenzene, diallyl phthalate and ethylene glycol dimethacrylate.

Further, the co-crosslinking agent is one of trimethylolpropane triacrylate, trimethylolpropane trimethacrylate, triallyl cyanurate and triallyl isocyanurate.

Further, the initiator is one of dibenzoyl peroxide, dicumyl peroxide and azobisisobutyronitrile.

Further, in step (1) and step (2), a combination of two of a helical ribbon agitator, a screw agitator, a frame agitator, a paddle agitator, a turbine agitator, a polytetrafluoroethylene agitator, a dispersion disc and an emulsifying machine is used for stirring.

A hierarchical porous polymeric material is prepared by the preparation method according to the present application.

Further, the hierarchical porous polymeric material has a density of 0.20-0.60 g/cm³, and a compressive strength of 5-31 MPa.

Further, the hierarchical porous polymeric material has a hierarchical micro-porous structure, and pore throats and partially interpenetrating opening structures are distributed on pore walls;

micro-pores have a pore size of 3-50 μm, and the pore throats have a size of 100 nm-2 μm.

Further, the hierarchical porous polymeric material has an average thermal conductivity coefficient of 0.054-0.091 W/(m·K).

Compared with the existing technology, the present application has the following beneficial effects:

In the method for preparing a hierarchical porous polymeric material of the present application, a gel emulsion is used as a template, and the system consists of two phases with completely different properties: one is a continuous phase (an oil phase), and the other is a dispersed phase (a water phase); by taking a water-in-oil (W/O) gel emulsion as a template, after the gel emulsion is formed, each tiny droplet is equivalent to a tiny heat transfer unit, the interface between the two phases is huge, and there are many collision opportunities of reactants and the reaction efficiency is high; in the polymerization process of the gel emulsion, hydrophilic and lipophilic regions exist at the same time, so that two kinds or two types of reactants with opposite polarities can be dissolved at the same time, and the oil phase system can also dissolve a variety of components with different polarities, therefore, a proper amount of a polar polymer is introduced into the oil phase as a pore-forming agent, and the porous structure, pore throat, and the contents and sizes of pores and throats can be effectively controlled by regulating the types, polarities and contents of the polymerizable monomer and polar polymer, so as to prepare hierarchical porous polymeric materials; in addition, by taking a water-in-oil (W/O) gel emulsion as a template, water, as a medium with high specific heat capacity and good thermal conductivity, quickly absorbs/releases heat during the polymerization process, and at the same time, the problem of explosive polymerization caused by rapid heat release in the polymerization process of high-density porous materials is solved by using fine pore throats on the pore walls of the material and partially interpenetrating structures, so that the qualified rate of the material and production safety are guaranteed. Furthermore, based on the special internal porous structure of the material, the mass transfer problem in the drying process of a wet material after polymerization is completed, and the problems of large energy consumption, high cost and even structural damage in the drying process of the wet material are overcome.

The present application provides a hierarchical porous polymeric material, which has a density of 0.20-0.60 g/cm³ and a hierarchical porous structure. The rich porous structures come from the following three aspects: (1) by adopting a water-in-oil (W/O) gel emulsion as a template, after thermal polymerization is completed, water droplets that do not participate in chemical reaction form a rich microporous structure in the material system, and the number of such micropores is large and the size is relatively large; (2) a gel emulsion system contains an oil phase (a polymerizable monomer, a cross-linking agent, an auxiliary cross-linking agent, and an appropriate amount of a polar polymer) and a water phase, and by using the affinity difference between nonpolar polymerizable monomer in the oil phase, its polymerized product and the polar polymer and the gradual phase separation phenomenon between a nonpolar polymer generated by a small-molecular polymerizable monomer and the polar polymer as a pore-forming agent, tiny pore throats and even interpenetrating porous structures are generated on the pore walls of the prepared material, and the pore sizes are relatively small; (3) the pore size, the content and size of the pore throats and porous structure are effectively controlled by adjusting the oil-water ratio content, the types, polarities and contents of the polymerizable monomer and polar polymers. To sum up, the hierarchical porous polymeric material prepared by the present application has fine pore throats and partially interpenetrating open porous structures on the walls of micropores, so that the good heat transfer and zero explosion in the polymerization process enable high product qualification rate of materials with 0.20-0.60 g/cm³. The wet material obtained by polymerization has rich pores, small mass transfer resistance, fast drying rate, low drying energy consumption and controllable cost; at the same time, the compressive strength of the hierarchical porous polymeric material of the present application is 5-31 MPa, and compared with the compressive strength (7-35 MPa) of closed-pore foam materials with the same density on the market, the mechanical properties are not obviously attenuated, meanwhile, the hierarchical porous polymeric material has excellent static load resistance.

The present application takes the gel emulsion as a template, and also has many advantages in production: (1) the gel emulsion can be formed by stirring at room temperatures and normal pressures, with thermal polymerization at medium and low temperatures, mild reaction conditions and short production period; (2) hydrophilic and lipophilic regions exist at the same time, and the interface between the two phases is huge, which solves the problem of explosive polymerization caused by poor heat transfer in the polymerization process of porous materials (especially high-density materials), making scaled-up mass production possible; (3) the production process is green and environment-friendly, and no three wastes are discharged; (4) a series of porous materials with different densities, pore sizes, porosities and internal phase structures can be obtained by adjusting the oil-water ratio, the types and contents of the polymerizable monomers and polymer pore-forming agents; (5) the drying cycle, cost and energy consumption of materials are greatly reduced by drying under normal pressures; (6) the production technology and equipment are simple, and the investment in hardware and equipment in the early stage is relatively small.

### BRIEF DESCRIPTION OF DRAWINGS

FIG. 1 is an appearance picture of the gel emulsion, in which, FIG. 1(a), FIG. 1(b) and FIG. 1(c) are appearance pictures of the gel emulsions of Examples 1-3, respectively;

FIG. 2 is a microscope picture of the gel emulsion, wherein, FIG. 2(a), FIG. 2(b) and FIG. 2(c) are microscope pictures of the gel emulsions of Examples 1-3, respectively;

FIG. 3 is an appearance picture of a hierarchical porous polymeric material, wherein, FIG. 3(a), FIG. 3(b) and FIG. 3(c) are appearance pictures of the materials of Examples 1-3, respectively;

FIG. 4 is an SEM picture of the material of Example 2, wherein, FIG. 4(a) and FIG. 4(b) are pictures with different magnifications, respectively;

FIG. 5 is a drying rate curve of the hierarchical porous polymeric materials prepared in Examples 1-3;

FIG. 6 is a stress-strain curve of the hierarchical porous polymeric materials prepared in Examples 1-3 during compression;

FIG. 7 is a laboratory scaled-up production picture (6 L) of the gel emulsion of Example 2;

FIG. 8 is a scaled-up production picture of the hierarchical porous polymeric materials obtained in Example 2.

### DESCRIPTION OF EMBODIMENTS

In order to make those skilled in the art better understand the solution of the present application, the technical solution in the embodiment of the present application will be described clearly and completely with the attached drawings. Obviously, the described embodiment is only a part of the embodiment of the present application, but not the whole embodiment. Based on the embodiments in the present application, all other embodiments obtained by those skilled in the art without creative work should fall into the scope of protection of the present application.

It should be noted that the terms “first” and “second” in the description and claims of the present application and the above drawings are used to distinguish similar objects, and are not necessarily used to describe a specific order or sequence. It should be appreciated that the data thus used are interchangeable under appropriate circumstances, so that the embodiments of the present application described herein can be implemented in other orders than those illustrated or described herein. Furthermore, the terms “including” and “having” and any variations thereof are intended to cover non-exclusive inclusion, for example, a process, method, system, product or equipment that includes a series of steps or units is not necessarily limited to those explicitly listed, but may include other steps or units not explicitly listed or inherent to such processes, methods, products or equipment.

The present application will be described in further detail with reference to the accompanying drawings:

### EXAMPLE 1

0.40 g of hydrophobic silica particles and 0.40 g of dibenzoyl peroxide were added into a beaker, and then 12.86 g of p-chlorostyrene, 2.88 g of divinylbenzene, 0.58 g of trimethylolpropane triacrylate and 2.88 g of polylactic acid (with a molecular weight of 10,000) were added in turn, and were stirred evenly with a polytetrafluoroethylene agitator to form a uniform reaction mixture; 80 g of deionized water was added to the mixture, and the mixture was stirred in a dispersion disc for 10 minutes to form a viscous and stable gel emulsion; the gel emulsion was subjected to thermal polymerization in a water bath pot and reacted at room temperature for 8 h, and then the mixture was heated to 70° C. to react for 12 h; drying was carried out at 80° C. to give a polymer material with a uniform and fine hierarchical porous structure having a complete appearance and a density of 0.20 g/cm³.

### EXAMPLE 2

0.80 g of hydrophobic silica particles and 0.80 g of azobisisobutyronitrile were added into a beaker, and then 25.73 g of α-methylstyrene, 5.76 g of diallyl phthalate, 1.16 g of trimethylolpropane trimethacrylate and 5.76 g of polyvinyl chloride paste resin (with a molecular weight of 62,000) were added in turn, and were evenly stirred in a dispersion disc to form a uniform reaction mixture; 60 g of deionized water was added to the mixture, and the mixture was stirred by an emulsifying machine for 15 minutes to form a viscous and stable gel emulsion; the gel emulsion was subjected to thermal polymerization in a water bath pot and reacted at room temperature for 8 h, and then the mixture was heated to 80° C. to react for 12 h; drying was carried out at 80° C. to give a polymer material with a uniform and fine hierarchical porous structure having a complete appearance and a density of 0.40 g/cm³.

### EXAMPLE 3

1.20 g of hydrophobic silica particles and 1.20 g of dicumyl peroxide were added into a beaker, and then 35.72 g of 4-methylstyrene, 8.64 g of ethylene glycol dimethacrylate, 1.73 g of triallyl cyanurate and 8.84 g of polyacrylamide (with a molecular weight of 15,000) were added in turn, and were stirred evenly with a polytetrafluoroethylene agitator to form a uniform reaction mixture; 40 g of deionized water was added to the mixture, and the mixture was stirred by an emulsifying machine for 20 minutes to form a viscous and stable gel emulsion; the gel emulsion was subjected to thermal polymerization in a water bath pot and reacted at 40° C. for 4 h, and then the mixture was heated to 90° C. to react for 10 h; drying was carried out at 80° C. to give a polymer material with a uniform and fine hierarchical porous structure having a complete appearance and a density of 0.60 g/cm³.

### EXAMPLE 4

0.50 g of hydrophobic silica particles and 0.40 g of azobisisobutyronitrile were added into a beaker, and then 10.53 g of styrene, 3.29 g of m-chlorostyrene, 2.88 g of divinylbenzene, 0.58 g of triallyl isocyanurate and 1.92 g of polycarbonate (with a molecular weight of 35,000) were added in turn, and were evenly stirred in a dispersion disc to form a uniform reaction mixture; 80 g of deionized water was added to the mixture, and the mixture was stirred for 20 minutes with a helical ribbon agitator to form a viscous and stable gel emulsion; the gel emulsion was subjected to thermal polymerization in a water bath pot and reacted at 30° C. for 5 h, and then the mixture was heated to 90° C. to react for 12 h; drying was carried out at 80° C. to give a polymer material with a uniform and fine hierarchical porous structure having a complete appearance and a density of 0.20 g/cm³.

### EXAMPLE 5

1.00 g of hydrophobic silica particles and 0.90 g of dibenzoyl peroxide were added into a beaker, and then 13.83 g of 2-methylstyrene, 13.83 g of o-chlorostyrene, 5.76 g of divinylbenzene, 1.15 g of trimethylolpropane trimethacrylate and 3.84 g of polyvinyl alcohol (with a molecular weight of 80,000) were added in turn, and were stirred uniformly by a helical ribbon agitator to form a uniform reaction mixture; 60 g of deionized water was added to the mixture, and the mixture was stirred with a paddle agitator for 15 minutes to form a viscous and stable gel emulsion; the gel emulsion was subjected to thermal polymerization in a water bath pot and reacted at 35° C. for 6 h, and then the mixture was heated to 90° C. to react for 8 h; drying was carried out at 80° C. to give a polymer material with a uniform and fine hierarchical porous structure having a complete appearance and a density of 0.40 g/cm³.

### EXAMPLE 6

1.10 g of hydrophobic silica particles and 1.20 g of dicumyl peroxide were added into a beaker, and then 12.44 g of styrene, 29.03 g of 4-ethylstyrene, 8.64 g of diallyl phthalate, 1.73 g of trimethylolpropane trimethacrylate and 5.76 g of polyvinyl acetate (with a molecular weight of 50,000) were added in turn, and were evenly stirred by a turbine agitator to form a uniform reaction mixture; 40 g of deionized water was added to the mixture, and the mixture was stirred for 20 minutes in a dispersion disc to form a viscous and stable gel emulsion; the gel emulsion was subjected to thermal polymerization in a water bath pot and reacted at room temperature for 7 h, and then the mixture was heated to 70° C. to react for 10 h; drying was carried out at 80° C. to give a polymer material with a uniform and fine hierarchical porous structure having a complete appearance and a density of 0.60 g/cm³.

### EXAMPLE 7

0.42 g of hydrophobic silica particles and 0.50 g of azobisisobutyronitrile were added into a beaker, and then 9.83 g of 4-methylstyrene, 4.96 g of 4-ethylstyrene, 2.88 g of ethylene glycol dimethacrylate, 0.58 g of triallyl cyanurate and 0.96 g of polyvinyl chloride paste resin (with a molecular weight of 80,000) were added in turn, and were stirred evenly in a dispersion disc to form a uniform reaction mixture; 80 g of deionized water was added to the mixture, and the mixture was stirred with a screw agitator for 20 minutes to form a viscous and stable gel emulsion; the gel emulsion was subjected to thermal polymerization in a water bath pot and reacted at 40° C. for 8 h, and then the mixture was heated to 70° C. to react for 6 h; drying was carried out at 80° C. to give a polymer material with a uniform and fine hierarchical porous structure having a complete appearance and a density of 0.20 g/cm³.

### EXAMPLE 8

0.90 g of hydrophobic silica particles and 0.90 g of dibenzoyl peroxide were added into a beaker, and then 20.50 g of styrene, 9.07 g of p-chlorostyrene, 5.76 g of ethylene phthalate, 1.15 g of trimethylolpropane trimethacrylate and 1.92 g of polyvinyl alcohol (with a molecular weight of 40,000) were added in turn, and were stirred uniformly by a helical ribbon agitator to form a uniform reaction mixture; 60 g of deionized water was added to the mixture, and the mixture was stirred by an emulsifying machine for 15 minutes to form a viscous and stable gel emulsion; the gel emulsion was subjected to thermal polymerization in a water bath pot and reacted at room temperature for 8 h, and then the mixture was heated to 90° C. to react for 7 h; drying was carried out at 80° C. to give a polymer material with a uniform and fine hierarchical porous structure having a complete appearance and a density of 0.40 g/cm³.

### EXAMPLE 9

1.00 g of hydrophobic silica particles and 1.20 g of azobisisobutyronitrile were added into a beaker, and then 24.14 g of p-chlorostyrene, 20.22 g of 2-methylstyrene, 8.64 g of divinylbenzene, 1.73 g of triallyl isocyanurate and 2.88 g of polyacrylamide (with a molecular weight of 40,000) were added in turn, and were evenly stirred in a dispersion disc to form a uniform reaction mixture; 40 g of deionized water was added to the mixture, and the mixture was stirred for 20 minutes with a turbine agitator to form a viscous and stable gel emulsion; the gel emulsion was subjected to thermal polymerization in a water bath pot and reacted at room temperature for 8 h, and then the mixture was heated to 80° C. to react for 5 h; drying was carried out at 80° C. to give a polymer material with a uniform and fine hierarchical porous structure having a complete appearance and a density of 0.60 g/cm³.

### EXAMPLE 10

0.60 g of hydrophobic silica particles and 0.50 g of dicumyl peroxide were added into a beaker, and then 13.54 g of styrene, 3.08 g of ethylene glycol dimethacrylate, 0.88 g of trimethylolpropane trimethacrylate, 0.71 g of polyvinyl chloride paste resin (with a molecular weight of 62,000) and 0.70 g of polyvinyl alcohol (with a molecular weight of 40,000) were added in turn, and were stirred evenly in a dispersion disc to form a uniform reaction mixture; 80 g of deionized water was added to the mixture, and the mixture was stirred by an emulsifying machine for 20 minutes to form a viscous and stable gel emulsion; the gel emulsion was subjected to thermal polymerization in a water bath pot and reacted at 40° C. for 8 h, and then the mixture was heated to 70° C. to react for 8 h; drying was carried out at 80° C. to give a polymer material with a uniform and fine hierarchical porous structure having a complete appearance and a density of 0.20 g/cm³.

### EXAMPLE 11

0.70 g of hydrophobic silica particles and 0.80 g of azobisisobutyronitrile were added into a beaker, and then 19.56 g of p-chlorostyrene, 8.09 g of 4-ethylstyrene, 4.67 g of divinylbenzene, 0.83 g of trimethylolpropane triacrylate, 2.90 g of polycarbonate (with a molecular weight of 20,000) and 2.45 g of polyvinyl acetate (with a molecular weight of 50,000) were added in turn, and were stirred by a paddle agitator to form a uniform reaction mixture; 60 g of deionized water was added to the mixture, and the mixture was stirred for 20 minutes in a dispersion disc to form a viscous and stable gel emulsion; the gel emulsion was subjected to thermal polymerization in a water bath pot and reacted at 35° C. for 8 h, and then the mixture was heated to 85° C. to react for 9 h; drying was carried out at 80° C. to give a polymer material with a uniform and fine hierarchical porous structure having a complete appearance and a density of 0.40 g/cm³.

### EXAMPLE 12

1.00 g of hydrophobic silica particles and 0.90 g of dibenzoyl peroxide were added into a beaker, and then 18.65 g of α-methylstyrene, 22.82 g of 4-ethylstyrene, 7.46 g of ethylene glycol dimethacrylate, 1.20 g of trimethylolpropane trimethacrylate, 4.63 g of polyvinyl acetate (with a molecular weight of 30,000) and 3.28 g of polyacrylamide (with a molecular weight of 15,000) were added in turn, and were evenly stirred in a dispersion disc to form a uniform reaction mixture; 40 g of deionized water was added to the mixture, and the mixture was stirred by an emulsifying machine for 25 minutes to form a viscous and stable gel emulsion; the gel emulsion was subjected to thermal polymerization in a water bath pot and reacted at 40° C. for 5 h, and then the mixture was heated to 75° C. to react for 10 h; drying was carried out at 80° C. to give a polymer material with a uniform and fine hierarchical porous structure having a complete appearance and a density of 0.60 g/cm³.

The examples listed above are only for the explanation of the present application, and cannot be used to limit the protection scope of the present application. Those skilled in the art can make other transformations or modifications according to the method of the present application, therefore all equivalent or similar technical solutions are to be covered within the protection scope of the present application.

The present application will be described in further detail with reference to the accompanying drawings:

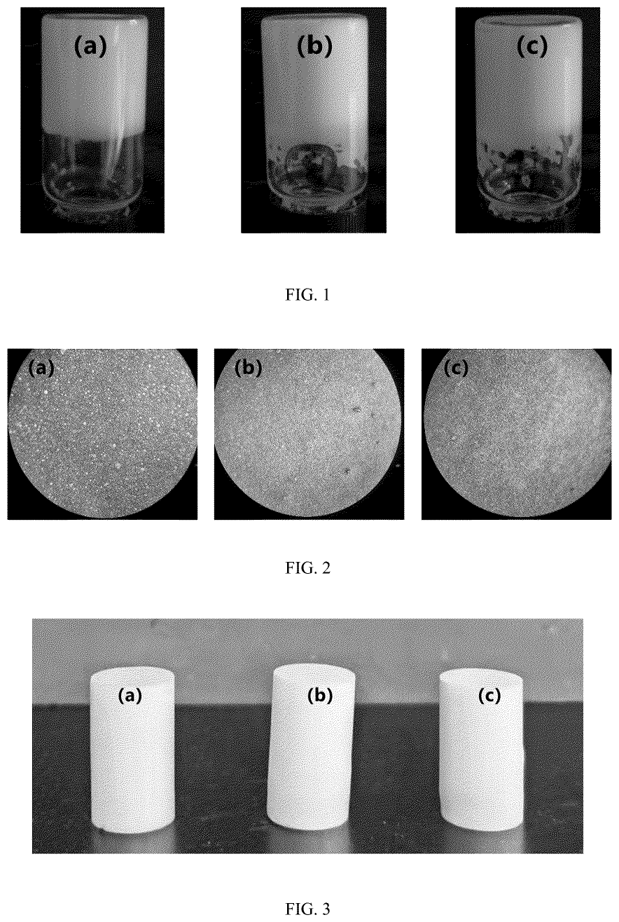

Referring to FIG. 1, FIG. 1(a), FIG. 1(b) and FIG. 1(c) are appearance pictures of gel emulsions of Examples 1-3, respectively; it can be seen from the figures that the gel emulsions of Examples 1-3 are white pastes that are uniform and stable, do not flow upside down and have good viscoelasticity, showing that a gel emulsion system with stable performance can be prepared in Examples 1-3.

Referring to FIG. 2, FIG. 2(a), FIG. 2(b) and FIG. 2(c) are microscopic pictures of the gel emulsions of Examples 1-3, respectively, with a microscope magnification of 100 times; as can be seen from the figures, the gel emulsions of Examples 1-3 are of a water-in-oil (W/O) structure, and the system has rich hierarchical microporous structure.

Referring to FIG. 3, FIG. 3(a), FIG. 3(b) and FIG. 3(c) are pictures of the appearances of materials in Examples 1-3, respectively; as can be seen from the figures, the hierarchical porous polymeric materials prepared in Examples 1-3 have a uniform and complete appearance and excellent overall performance without structural defects

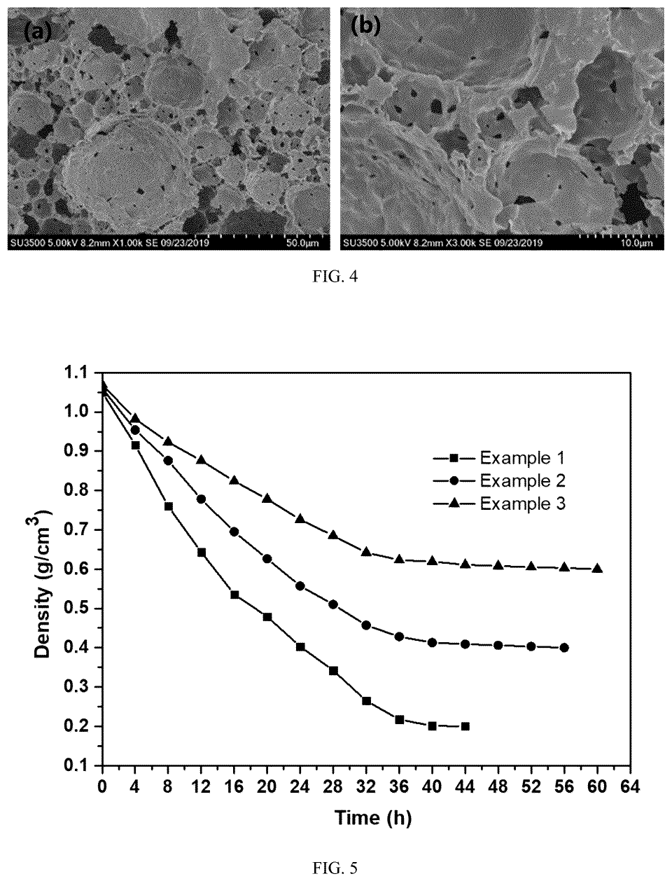

Referring to FIG. 4, it is an SEM picture of the hierarchical porous polymeric material obtained in Example 2. FIGS. 4(a) and 4(b) are pictures with different magnifications, and the microstructure was observed by using a Quanta200 scanning electron microscope. The surface of the sample needs to be sprayed with gold before testing, and the accelerated voltage is 20 kV and the emission current is 100 μA in SEM testing. According to the present application, a water-in-oil (W/O) gel emulsion is used as a template, so that a continuous phase (an oil phase) wraps a dispersed phase (a water phase), and the water phase acts as most pore-forming agents in the emulsion system; meanwhile, a proper amount of a polar polyvinyl chloride paste resin is introduced into the continuous phase (an oil phase), and by using the affinity difference between nonpolar small molecule polymerizable monomer (α-methylstyrene) and its generated polymer, polar polymer (PVC paste resin) in the continuous phase and dispersed phase (water), and the gradual partial phase separation between the polymer (nonpolar) generated by α-methylstyrene and PVC paste resin (polar, with a molecular weight of 62,000), fine pore throats can be generated on the pore wall of the prepared material; there are abundant porous structures in the material. As can be seen from the figure, the material contains rich hierarchical porous structures, the pore size is 3-50 μm, and fine pore throats and partial open porous structures (with a size of 100 nm-2 μm) are formed on the pore wall of the polymer material, which will be beneficial to the mass transfer in the drying process of the material and make up for the defects of large energy consumption and long period in the drying process of the wet material.

Referring to FIG. 5, there are the drying rate curves of the hierarchical porous polymeric materials prepared in Examples 1-3. The materials were all 100 mm*50 mm*20 mm in size, and were dried in a drying oven at 80° C. It can be seen from the figure that the materials can be completely dried after about 60 h; the drying rate of low-density materials is slightly faster than that of high-density materials because of the higher water content and lower oil content in the system, the thinner pore wall in the internal phase structure in the material, the larger pore throat and the richer partially interpenetrating porous structures.

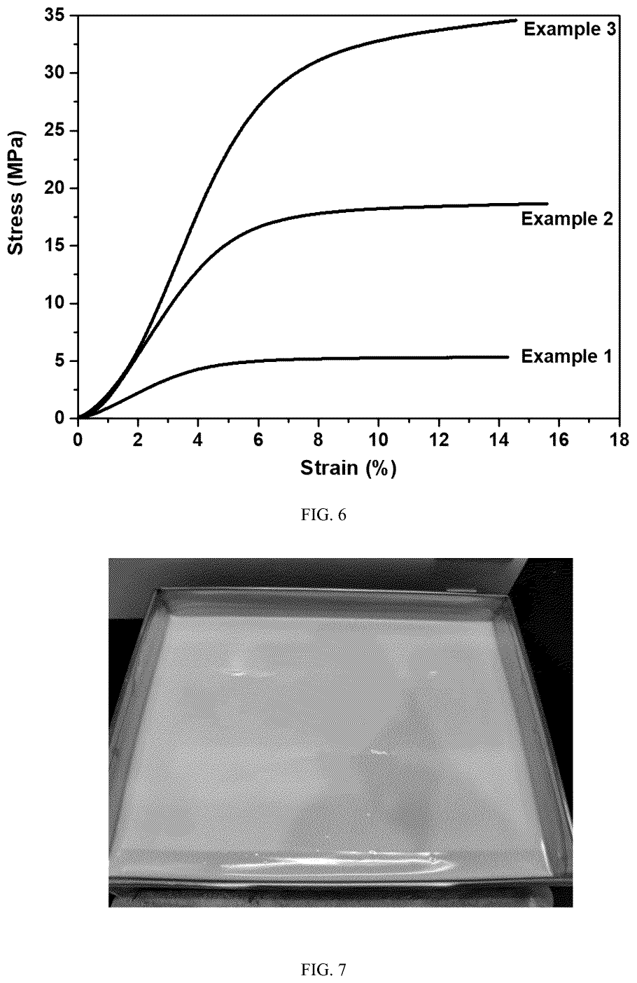

Referring to FIG. 6, there are the stress-strain curves of the hierarchical porous polymeric materials prepared in Examples 1-3 during compression. The compressive properties of the hierarchical porous polymeric materials with different densities were tested by WDW-100M microcomputer-controlled electronic universal testing machine. It can be seen from FIG. 6: (1) with the increase of the density of the material, the compressive strength of the material increases, which is because the water-in-oil (W/O) gel emulsion is used as a template in the present application, and with the increase of the density, the water phase content in the system decreases, the oil phase content increases, the pore wall in the internal phase structure of the material becomes thicker, and the ability of resisting deformation and load during compression is enhanced; (2) when the strain is less than 8%, the hierarchical porous polymeric material undergoes general elastic deformation, and the curve shows a linear growth trend, which is because the material has rich porous structures, and the pore structure is deformed and the presented curve grows linearly when the material is stressed, and at the same time, the bond length and bond angle change caused by small-sized moving units in the molecules are small and recoverable, so the stress-strain curve of the material basically conforms to Hooke's law; when the strain is more than 8%, the hierarchical porous polymeric material undergoes plastic deformation, and the stress-strain curve is in the plateau region, the strain of the material increases while the stress remains basically unchanged, which is because that the pore structure of the material is not deformed obviously under the action of a large external force and the frozen molecular chain segments are oriented along the direction of the external force.

Referring to FIG. 7, it is a picture (6 L) of the gel emulsion obtained in Example 2, and the mold size is 400 mm * 300 mm * 50 mm. It can be seen from the figure that the gel emulsion obtained in the scaled-up production in laboratory is also a uniform and stable white paste with good viscoelasticity, which shows that the scaled-up production Example 2 has a good stability.

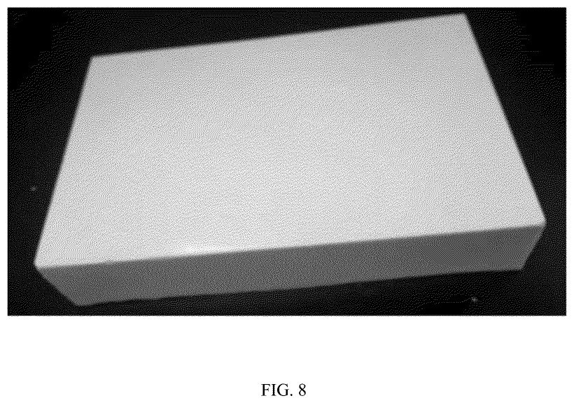

Referring to FIG. 8, it is a picture of a laboratory scaled-up production of the hierarchical porous polymeric material obtained in Example 2, and the size can reach 400 mm * 300 mm * 50 mm. The appearance of the hierarchical porous polymeric material in the scaled-up production is basically the same as that of the sample in FIG. 3(b), and it still maintains the characteristics of uniform and complete appearance, no structural defects, excellent overall performance and the like, indicating that the preparation method of the present application has a small amplification effect, and the defects of large molding sizes and limited shapes of mass-produced materials can be effectively avoided, and at the same time, the problem of explosive polymerization caused by a high content of oil-phase components in high-density materials and improper heat control during polymerization can be solved, so that the qualification rate of materials is improved.

The water absorptions of the hierarchical porous polymeric materials prepared in Examples 1-3 of the present application were tested, and the test results are shown in Table 1. It can be seen that with the extension of time, the water absorption of each material gradually increases and then tends to be stable; the water absorption rates of low-density materials are higher than those of high-density materials, and this is because the content of water phases is more and that of the oil phases is less in the low-density materials system, the pore walls in the internal phase structure of the materials are thinner, the micro-pore size is larger, there are more pores and throats, and the interpenetrating porous structures are richer, and water can enter the materials relatively easily, which increases the water absorption rate.

The thermal conductivities of the hierarchical porous polymeric materials prepared in Examples 1-3 of the present application were tested. As shown in Table 2, the corresponding material densities were 0.20 g/cm³, 0.40 g/cm³ and 0.60 g/cm³, respectively. According to the national standard GB/T 10297-2015 “Test method for thermal conductivity of nonmetal solid materials by hot-wire method”, the material size is 30 mm*30 mm*3 mm, and three samples are selected for one group. According to the data in the table, the values of average thermal conductivity of the porous materials prepared in Examples 1-3 at normal temperature and pressure are 0.054 W/(mK), 0.073 W/(mK) and 0.091 W/(mK), respectively, and the thermal conductivity gradually increases with the increase of density of the material. The reasons are as follows: (1) the air in the internal pores of the porous materials is static and cannot flow freely, so the more internal hierarchical porous structures, the weaker the effect of air convection heat transfer; (2) the richer the pore/channel structures in the material, the longer the heat conduction path, which will greatly weaken the solid heat conduction; (3) the tiny holes/pores in the material will greatly weaken the heat conduction caused by the collision of air molecules. At normal temperature and pressure, the thermal conductivity of water is 0.59 W/(mk), and that of air is 0.026 W/(mk). Usually, materials with thermal conductivities less than 0.2 W/(mk) are called thermal insulation materials, which shows that the prepared hierarchical porous polymeric material has excellent thermal insulation and heat preservation performance, and can be used as a high-strength thermal insulation material.

Table 1 Test results of mass water absorption of hierarchical porous polymeric materials in Examples 1-3

| Project | Example 1 | Example 2 | Example 3 |
|---|---|---|---|
| 24 h | 2.13% | 1.82% | 1.57% |
| 48 h | 3.39% | 2.43% | 1.75% |
| 72 h | 4.59% | 2.95% | 1.86% |
| 96 h | 5.47% | 3.46% | 1.93% |

Table 2 Test results of thermal conductivity of hierarchical porous polymeric materials in Example 1-3

| Project | | Example 1 | Example 2 | Example 3 |
|---|---|---|---|---|
| Density (g/cm³) | | 0.20 | 0.40 | 0.60 |
| | Sample 1# | 0.053 | 0.073 | 0.088 |
| Thermal conductivity | Sample 2# | 0.055 | 0.075 | 0.092 |
| (W/(m · k)) | Sample 3# | 0.054 | 0.071 | 0.093 |
| | Average value | 0.054 | 0.073 | 0.091 |

What is described above is only for explaining the technical idea of the present application, and cannot be used to limit the protection scope of the present application. Any changes made on the basis of the technical solution according to the technical idea proposed by the present application shall fall within the protection scope of the claims of the present application.

What is claimed is:

1. A method for preparing a hierarchical porous polymeric material, comprising the following:
(1) mixing hydrophobic silica particles with an initiator, adding a polymerizable monomer, a crosslinking agent, an auxiliary crosslinking agent and a pore-forming agent, and uniformly stirring to obtain a reaction mixture;
(2) adding water into the reaction mixture and stirring until a gel emulsion is formed;
wherein in the gel emulsion, in parts by weight, 0.40-1.20 parts of hydrophobic silica particles, 0.40-1.20 parts of the initiator, 12.86-44.35 parts of the polymerizable monomer, 2.88-8.64 parts of the crosslinking agent, 0.58-1.73 parts of the auxiliary crosslinking agent, and 0.96-8.64 parts of the pore-forming agent are contained per 40-60 parts of deionized water;
the polymerizable monomer is one or more of p-chlorostyrene, m-chlorostyrene, o-chlorostyrene, styrene, α-methylstyrene, 2-methylstyrene, 4-methylstyrene and 4-ethylstyrene;
the pore-forming agent is one or two of polylactic acid, polyacrylamide, polycarbonate, polyvinyl chloride paste resin, polyvinyl alcohol and polyvinyl acetate with a number average molecular weight of 10,000-80,000; and
(3) carrying out staged thermal polymerization on the gel emulsion, which reacting at room temperature to 40° C. for 4-8 h, and heating to 70-90° C. for reacting for 4-12 h to complete polymerization, and drying to obtain the hierarchical porous polymeric material.

2. The method for preparing a hierarchical porous polymeric material according to claim 1, wherein the crosslinking agent is one of divinylbenzene, diallyl phthalate and ethylene glycol dimethacrylate.

3. The method for preparing a hierarchical porous polymeric material according to claim 1, wherein the co-crosslinking agent is one of trimethylolpropane triacrylate, trimethylolpropane trimethacrylate, triallyl cyanurate and triallyl isocyanurate.

4. The method for preparing a hierarchical porous polymeric material according to claim 1, wherein the initiator is one of dibenzoyl peroxide, dicumyl peroxide and azobisisobutyronitrile.

5. The method for preparing a hierarchical porous polymeric material according to claim 1, wherein in step (1) and step (2), a combination of two of a helical ribbon agitator, a screw agitator, a frame agitator, a paddle agitator, a turbine agitator, a polytetrafluoroethylene agitator, a dispersion disc and an emulsifying machine is used for stirring.

6. A hierarchical porous polymeric material, which is prepared by the preparation method according to claim 1.

7. The hierarchical porous polymeric material according to claim 6, wherein the hierarchical porous polymeric material has a density of 0.20-0.60 g/cm³, and a compressive strength of 5-31 MPa.

8. The hierarchical porous polymeric material according to claim 6, wherein the hierarchical porous polymeric material has a hierarchical micro-porous structure, and pore throats and partially interpenetrating opening structures are distributed on pore walls;
micro-pores have a pore size of 3-50 μm, and the pore throats have a size of 100 nm-2 μm.

9. The hierarchical porous polymeric material according to claim 6, wherein the hierarchical porous polymeric material has an average thermal conductivity coefficient of 0.054-0.091 W/(mK).
